(19) United States
(12) Patent Application Publication
(10) Pub. No.: US 2025/0320906 A1
(43) Pub. Date: Oct. 16, 2025

(54) Torque damper

(71) Applicant: Jiangyin Weiren Aluminum Co., Ltd., Wuxi (CN)

(72) Inventor: Yiyang Ni, Wuxi (CN)

(21) Appl. No.: 19/173,017

(22) Filed: Apr. 8, 2025

(30) Foreign Application Priority Data
Apr. 16, 2024 (CN) 202410451446.X

(51) Int. Cl. F16F 15/18

(52) U.S. Cl. CPC F16F 15/18

(57) ABSTRACT

A torque damper includes a torque shaft and a first damping device for applying a force opposite to a rotational direction of the torque shaft, where the first damping device includes at least one first magnet connected to the torque shaft and at least one second magnet arranged on a motion trajectory of the first magnet. The first magnet and the second magnet have the same polarities at opposite positions thereof. In the present disclosure, in view of a repulsive interaction between magnets of like polarities, the magnets of like polarities are arranged as a damping device to provide a damping force opposite to the rotational direction of the torque shaft, thereby achieving a vibration damping effect. Additionally, an electromagnetic damping device is further arranged. The present disclosure features a simple structure, fast response, good damping effect, and convenient damping force adjustment.

### TECHNICAL FIELD

The present disclosure relates to the technical field of dampers, and in particular to a magnetomotive torque damper.

### BACKGROUND

A torque damper is a component mounted on a torque shaft and configured to generate a damping torque or counter torque to reduce an amplitude of torsional vibration of the torque shaft. A torque damper of the prior art usually employs elastic components such as rubber, a spring, a hydraulic cylinder, or a pneumatic cylinder to provide a buffered damping force or an opposing torque so as to resist or reduce the amplitude of torsional vibration of the torque shaft. However, damping components of the prior art have the defects of slow response, inconvenient damping force adjustment, structural complexity, or high manufacturing costs.

### SUMMARY

To overcome the defects in the prior art, an objective of the present disclosure is to provide a magnetomotive torque damper featuring a simple structure, fast response, good damping effect, and convenient damping force adjustment.

To achieve the above objective, the present disclosure adopts the following technical solution:
a torque damper, including a torque shaft and a first damping device for applying a force opposite to a rotational direction of the torque shaft, where the first damping device includes at least one first magnet connected to the torque shaft and at least one second magnet arranged on a motion trajectory of the first magnet; and the first magnet and the second magnet have the same polarities at opposite positions thereof. When the torque shaft rotates under the action of an external force, the first magnet connected to the torque shaft rotates synchronously, and gets closer to the second magnet. Since polarities at opposite positions of the first magnet and the second magnet are the same, a force that is opposite to a rotation direction of the torque shaft is generated between the first magnet and the second magnet, to resist rotation of the torque shaft, so as to achieve a vibration damping effect. Magnetic fields exhibit characteristics of immediate response to repulsive forces of like polarities, and when two magnetic fields approach each other, the repulsive forces become larger. Therefore, the damper with a magnetic damping device has the characteristics of sensitive response and damping force increase with the torque shaft, as well as a favorable vibration damping effect. Further, when the torque shaft rotates clockwise or counterclockwise, a magnetic damping device is always capable of providing a same damping force, thereby achieving a same vibration damping effect.

Further features include: the first magnet is coaxially arranged on the torque shaft, and the second magnet is arranged inside a fixed ring and coaxially arranged with the torque shaft. The first magnet and the second magnet are coaxially arranged with the torque shaft, and synchronously rotate with the torque shaft, forming a compact structure.

Preferably, a plurality of first magnets are uniformly arranged around a circumference of the torque shaft, and a plurality of second magnets are correspondingly arranged circumferentially in the fixed ring; and the first magnets and the second magnets are arranged in a staggered manner, and a gap is formed between the first magnet and the second magnet adjacent to each other. Staggered arrangement of the first magnets and the second magnets ensures a more uniform force resisting rotation of the torque shaft, enhancing the vibration damping effect.

Further, an axial distance between the torque shaft and the fixed ring can be changed. By adjusting the axial distance between the torque shaft and the fixed ring, a relative magnetic field area between the first magnet and the second magnet can be adjusted. When magnetic fields of the first magnet and the second magnet are completely aligned, a maximum damping force is generated; and when the magnetic fields of the first magnet and the second magnet are completely detached, no damping force is generated. A damping force of the damper can be conveniently adjusted by changing the axial distance between the torque shaft and the fixed ring.

Preferably, a second damping device is connected to the torque shaft, and the second damping device comprises an electromagnetic coil forming a circuit and a corresponding third magnet; and the electromagnetic coil moves relative to the third magnet, such that current is generated by cutting a magnetic line, a reverse magnetic field is generated simultaneously, and a damping force that prevents relative motion thereof is formed. Arrangement of the second damping device can further increase the damping force and improve the vibration damping effect. When the torque shaft rotates faster, the electromagnetic coil cuts the magnetic line of the third magnet faster, such that greater current and a larger reverse magnetic field are generated, with a larger damping force. An electromagnetic damping device has advantages of fast response and favorable vibration damping effect.

Preferably, a diode is connected in series in a circuit of the electromagnetic coil. Arrangement of the diode achieves only unidirectional conduction of the circuit of the electromagnetic coil, that is, only when the electromagnetic coil moves relative to the third magnet in just one direction, a current circuit can be formed, and a reverse magnetic field can be generated, such that the vibration damping effect is achieved. When the electromagnetic coil moves relative thereto in an opposite direction, no current circuit can be formed, and the reverse magnetic field cannot be generated, such that no damping effect is achieved. A unidirectional damping effect is achieved through the series-connected diode. The second damping device and the first damping device of the present disclosure cooperate with each other to provide different damping forces in both rotational directions of the torque shaft of the damper, thereby adapting to different application scenarios.

Preferably, a rechargeable battery is arranged in the circuit of the electromagnetic coil. The rechargeable battery in the circuit of the electromagnetic coil achieves unidirectional damping of the electromagnetic coil, and the rechargeable battery is charged with unidirectional pulsed current generated, such that energy recovery and an energy-saving and environmentally friendly effect are achieved.

Preferably, a rheostat is connected in series in a circuit of the electromagnetic coil. Resistance of the rheostat can be changed to adjust a magnitude of current in the circuit of the electromagnetic coil and further modulate a strength of the reverse magnetic field, which facilitates adjustment of a damping force of a second damping device of the damper.

In an embodiment, the electromagnetic coil is arranged on the torque shaft, and the third magnet is arranged at an outer circumferential position of the electromagnetic coil. Rotation of the torque shaft drives the electromagnetic coil to cut a magnetic line of the third magnet, causing to generate current and a reverse magnetic field, thereby achieving the vibration damping effect.

In another embodiment, the third magnet is planarly arranged on the torque shaft, and the electromagnetic coil is a flat coil and arranged close to the third magnet. The electromagnetic coil is fixedly arranged, and the third magnet rotates with the torque shaft, thereby achieving the equivalent vibration damping effect.

In the present disclosure, in view of a repulsive interaction between magnets of like polarities, the magnets of like polarities are arranged as a damping device to provide a damping force opposite to the rotational direction of the torque shaft, thereby achieving a vibration damping effect. Additionally, an electromagnetic damping device is further arranged, and when the torque shaft rotates, an electromagnetic coil moves relative to the magnets, such that current is generated by cutting a magnetic line, a reverse magnetic field is generated simultaneously, and a damping force that prevents relative motion thereof is formed, thereby achieving the vibration damping effect. The present disclosure features a simple structure, fast response, good damping effect, and convenient damping force adjustment, and is applicable to various automobiles, electric vehicles, bicycles, and other scenarios requiring torsional vibration damping.

### BRIEF DESCRIPTION OF THE DRAWINGS

FIG. 1 is a combined schematic diagram of an embodiment of the present disclosure.

FIG. 2 is an exploded view of an embodiment of the present disclosure.

FIG. 3 is an exploded view of another embodiment of the present disclosure.

Reference numerals in the figures: 1—torque shaft; 2—first magnet; 3—second magnet; 4—fixed ring; 5—electromagnetic coil; 6—third magnet; 7—rechargeable battery; 8—rheostat; and 9—diode.

### DETAILED DESCRIPTIONS OF THE EMBODIMENTS

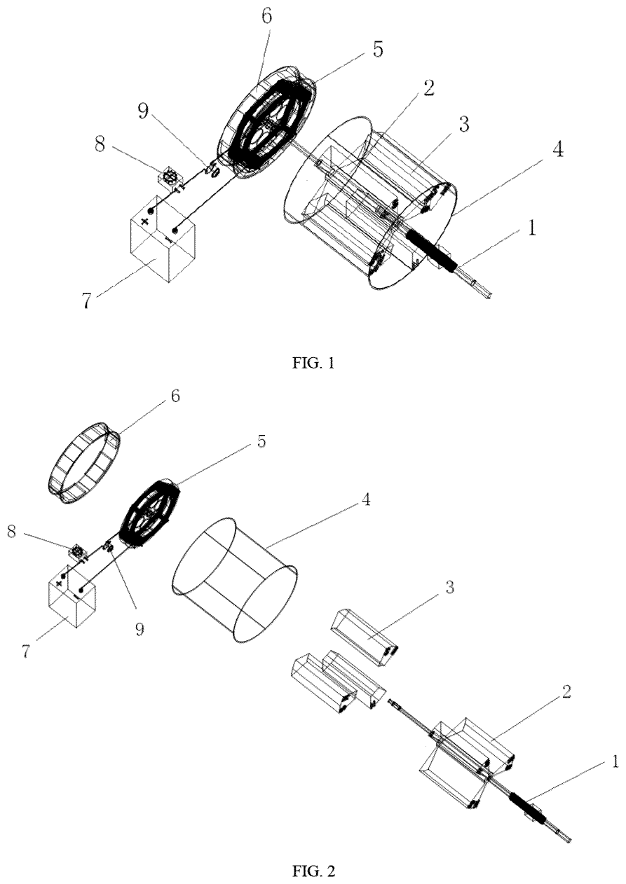

As illustrated in FIGS. 1-3, a torque damper includes a torque shaft 1, and a plurality of first magnets 2 are uniformly arranged around a circumference of the torque shaft 1. A fixed ring 4 is coaxially arranged on a side of the torque shaft 1, and a plurality of second magnets 3 are correspondingly arranged circumferentially in the fixed ring 4. The first magnets 2 and the second magnets 3 are arranged in a staggered manner, a gap is formed between the first magnet 2 and the second magnet 3 adjacent to each other, and opposite magnetic surfaces of the first magnet 2 and the second magnet 3 adjacent to each other have the same polarities.

When the torque shaft 1 rotates under the action of an external force, the first magnets 2 connected to the torque shaft 1 rotate synchronously, and get closer to the second magnets 3. Since the opposite magnetic surfaces of the first magnet 2 and the second magnet 3 adjacent to each other have the same polarities, a force that is opposite to a rotation direction of the torque shaft 1 is generated between the first magnet 2 and the second magnet 3, to resist rotation of the torque shaft 1, so as to achieve a vibration damping effect. When the torque shaft 1 rotates clockwise or counterclockwise, a magnetic damping device is always capable of providing a same damping force, thereby achieving a same vibration damping effect.

By changing an axial distance between the torque shaft 1 and the fixed ring 4, a magnetic field area corresponding to the magnetic surfaces of the first magnet 2 and the second magnet 3 can be adjusted. When magnetic fields of the first magnet 2 and the second magnet 3 are completely aligned, a maximum damping force is generated; and when the magnetic fields of the first magnet 2 and the second magnet 3 are completely detached, no damping force is generated. A damping force of the damper can be conveniently adjusted by changing the axial distance between the torque shaft 1 and the fixed ring 4.

As illustrated in FIGS. 1 and 2, in one embodiment, an electromagnetic coil 5 is arranged on the torque shaft 1, a fixed ring is arranged around an outer circumference of the electromagnetic coil 5, and a third magnet 6 is arranged inside the fixed ring. A diode 9 and a rheostat 8 are connected in series in a circuit of the electromagnetic coil 5, and a rechargeable battery 7 is further arranged in the circuit of the electromagnetic coil 5.

Rotation of the torque shaft 1 drives the electromagnetic coil 5 to cut a magnetic line of the third magnet 6, causing to generate current and a reverse magnetic field, thereby achieving the vibration damping effect. Arrangement of the diode 9 achieves only unidirectional conduction of the circuit of the electromagnetic coil 5, that is, only when the electromagnetic coil 5 moves relative to the third magnet 6 in just one direction, a current circuit can be formed, and a reverse magnetic field can be generated, such that the vibration damping effect is achieved. When the electromagnetic coil 5 moves relative thereto in an opposite direction, no current circuit can be formed, and the reverse magnetic field cannot be generated, such that no damping effect is achieved. A unidirectional damping effect is achieved through the series-connected diode 9.

The rheostat 8 in the circuit of the electromagnetic coil 5 is capable of adjusting a magnitude of current in the circuit of the electromagnetic coil 5 and further modulating a strength of the reverse magnetic field, which facilitates adjustment of a damping force of a second damping device of the damper.

The rechargeable battery 7 in the circuit of the electromagnetic coil 5 achieves unidirectional damping of the electromagnetic coil 5, and the rechargeable battery 7 is charged with unidirectional pulsed current generated, such that energy recovery and an energy-saving and environmentally friendly effect are achieved.

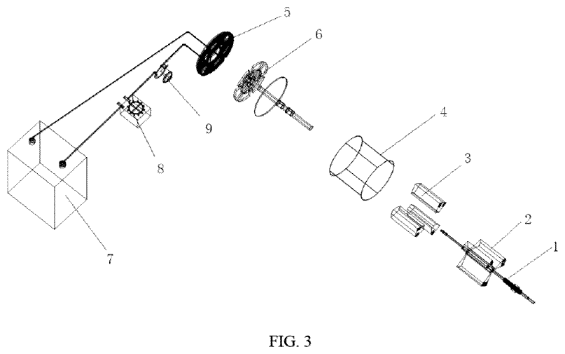

As illustrated in FIG. 3, in another embodiment, the third magnet 6 is planarly arranged on the torque shaft 1, and the electromagnetic coil 5 is a flat coil and arranged close to the third magnet 6. The diode 9 and the rheostat 8 are connected in series in the circuit of the electromagnetic coil 5, and the rechargeable battery 7 is further arranged in the circuit of the electromagnetic coil 5. The electromagnetic coil 5 is fixedly arranged, and the third magnet 6 rotates with the torque shaft 1, thereby achieving the equivalent vibration damping effect.

The magnetic damping device and an electromagnetic damping device of the present disclosure cooperate with each other to provide different damping forces in both rotational directions of the torque shaft 1 of the damper, thereby adapting to different application scenarios. The present disclosure features a simple structure, fast response, good damping effect, and convenient damping force adjustment, and is applicable to various automobiles, electric vehicles, bicycles, and other scenarios requiring torsional vibration damping.

What is claimed is:

1. A torque damper, comprising a torque shaft and a first damping device for applying a force opposite to a rotational direction of the torque shaft, wherein the first damping device comprises at least one first magnet connected to the torque shaft and at least one second magnet arranged on a motion trajectory of the first magnet; and the first magnet and the second magnet have the same polarities at opposite positions thereof.

2. The torque damper according to claim 1, wherein the first magnet is coaxially arranged on the torque shaft, and the second magnet is arranged inside a fixed ring and coaxially arranged with the torque shaft.

3. The torque damper according to claim 2, wherein a plurality of first magnets are uniformly arranged around a circumference of the torque shaft, and a plurality of second magnets are correspondingly arranged circumferentially in the fixed ring; and the first magnets and the second magnets are arranged in a staggered manner, and a gap is formed between the first magnet and the second magnet adjacent to each other.

4. The torque damper according to claim 1, wherein an axial distance between the torque shaft and the fixed ring can be changed to adjust a damping force.

5. The torque damper according to claim 1, wherein a second damping device is connected to the torque shaft, and the second damping device comprises an electromagnetic coil forming a circuit and a corresponding third magnet; and the electromagnetic coil moves relative to the third magnet, such that current is generated by cutting a magnetic line, a reverse magnetic field is generated simultaneously, and a damping force that prevents relative motion thereof is formed.

6. The torque damper according to claim 5, wherein a diode is connected in series in a circuit of the electromagnetic coil.

7. The torque damper according to claim 6, wherein a rechargeable battery is arranged in the circuit of the electromagnetic coil.

8. The torque damper according to claim 7, wherein a rheostat is connected in series in a circuit of the electromagnetic coil.

9. The torque damper according to claim 5, wherein the electromagnetic coil is arranged on the torque shaft, and the third magnet is arranged at an outer circumferential position of the electromagnetic coil.

10. The torque damper according to claim 5, wherein the third magnet is planarly arranged on the torque shaft, and the electromagnetic coil is a flat coil and arranged close to the third magnet.
